(19) United States
(12) Patent Application Publication
(10) Pub. No.: US 2005/0050147 A1
(43) Pub. Date: Mar. 3, 2005

(54) E-mail client system and method

(76) Inventors: Ali Jani, Fairfax, VA (US); Sanjay Shah, Bangalore (IN); Nayan Vadher, Gainesville, VA (US)

Correspondence Address: DLA PIPER RUDNICK GRAY CARY USA, LLP, 2000 UNIVERSITY AVENUE, E. PALO ALTO, CA, 94303-2248, US

(21) Appl. No.: 10/848,427

(22) Filed: May 17, 2004

Related U.S. Application Data
(60) Provisional application No. 60/498,877, filed on Aug. 29, 2003.

(51) Int. Cl. G06F 15/16

(52) U.S. Cl. 709/206

(57) ABSTRACT

An e-mail client system and method are described. The e-mail client enables organizations to store e-mail communication as part of the business software database and those stored e-mail communications would be available to any user of the software within the organization, so that the communication carried out historically can be referenced, retrieved and/or reused. The invention allows the business software users to communicate internally with other users as well as external contacts/entities such as customers and vendors.

### PRIORITY CLAIM

This application claims priority under 35 USC 119 to U.S. Provisional Patent Application Ser. No. 60/498,877, filed on Aug. 29, 2003 and entitled “E-mail Client System and Method” which is incorporated herein by reference.

### FIELD OF THE INVENTION

The present invention relates generally to an electronic mail (“e-mail”) management system. More particularly, it relates to a method to integrate an e-mail client with a business software application and an e-mail client system that can be used for sending and receiving mails to and from other users, including indexing, storing and retrieving all e-mail communication carried out with entities interacting with a business organization.

### BACKGROUND OF THE INVENTION

Any business organization would greatly benefit from an e-mail system that is integrated into its business software that is used to automate its processes and enables it to effortlessly communicate with the typical entities that it interacts with such as users, vendors and customers. While many generic e-mail clients such as Outlook, Outlook Express, Outlook Web Access, Entourage, Mac Mail and Eudora are available, the fact that they may not be easily integrated and share information with custom databases specific to a business automation software used by the business greatly limits the extent to which they can be exploited. When e-mail communication data is independent of the other transactions carried out and recorded in the business software, the communication data cannot be attached, indexed and referenced or retrieved from within the business software, based on the entities for which such business transactions have been carried out.

It is desirable to have an integrated e-mail client so that the organization can attach all e-mail communication exchanged with an external entity to other data in the business software that is specific to the entity and such data can be easily retrieved and examined, as and when required, by all concerned users of the software. The stored and accessible information is available across the organization to anyone concerned and enables organizations to manage their relationships with such entities in a better manner. Thus, it is desirable to provide an e-mail client system that achieves these solutions and it is to this end that the present invention is directed.

### SUMMARY OF THE INVENTION

The present invention provides a method to integrate an e-mail client with a business software application so as to enable the user of the e-mail client to send and receive e-mails and also store, index and retrieve the e-mails in the database. An exemplary implementation of the e-mail client of the present invention may be known as “Everest E-mail” and may be integrated into the Everest Advanced Edition (“Everest”) business software application developed by iCode, Inc. (“iCode”) The e-mail client allows a user to manage internal and external e-mail communication. The invention provides a mechanism for the a user to send and receive e-mails to/from other users, reply to e-mails, forward and delete e-mails, within and outside the organization. Users can also mark messages as read or unread and print e-mails. There is also provided a method for structuring, storing and retrieving e-mail communication of internal and external entities. This method has capabilities to create new folders, copy folders, delete folders, move folders, copy or move e-mails to different folders.

By integrating the e-mail client of the present invention with the database of the business software such as Everest, there is also provided an apparatus to centralize communication with external entities by providing various features. For example, the system provides configuration and supports POP3 and MAPI e-mail accounts for external communication. Internal communication does not require setting up e-mail accounts such as POP3 or MAPI. The system also provides an e-mail client for sending and receiving e-mails from customers, vendors and external entities. The system also scans a user's “Inbox” for each account and upon finding a match, links the e-mail address with the customer or vendor. The system also views all e-mails sent to a customer/vendor by any user in the organization ensuring that no correspondence is lost or is confined to a single user's Inbox. The system also automatically creates an address book with all customer/vendor e-mail addresses.

Thus, in accordance with the invention, a method to integrate an e-mail client with a business software application is provided. In the method, an e-mail account is set up for each user of the business software. Each e-mail account is managed by setting up preferences such as message formats or the notification of the arrival of an e-mail. The method further comprises creating and managing a centralized database of e-mail addresses by combining the global address book from a mail server, a user's personal address book and the e-mail addresses of contacts in the database of the business software. The method further identifies and associates e-mails received and sent with the contacts in the database of the business software and indexes and stores all e-mails thus associated in the database, along with attachments and related data in the centralized repository of the business software. The system also retrieves e-mails for the selected contacts. The e-mail message formats may include Plain Text, Rich Text Format and Hypertext Markup Language (HTML).

In accordance with another aspect of the invention, an e-mail client system is provided that comprises a computer program configured to execute instructions on a processor or computer. The instructions perform different functions. Thus, the e-mail client system sets up an e-mail account for each user of the business software with preferences such as message formats or notification of the arrival of an e-mail. The e-mail client also creates and manages a centralized database of e-mail addresses by combining the global address book from a e-mail server, a user's personal address book and the e-mail addresses of contacts in the database of the business software. The e-mail client further identifies and associates e-mails received and sent with the contacts in the database of the business software and indexes and stores all e-mails thus associated in the database, along with attachments and related data in the centralized repository of the business software. The e-mail client also retrieves e-mails for the selected contacts.

In accordance with yet another aspect of the invention, an e-mail client system is provided wherein the computer program further comprises a set of instructions to set up an e-mail account for each user of the business software with preferences such as message formats or notification of the arrival of an e-mail. The client further comprises means for creating and managing a centralized database of e-mail addresses by combining the global address book from a e-mail server, a user's personal address book and the e-mail addresses of contacts in the database of the business software, means to identify and associate e-mails received and sent with the contacts in the database of the business software and means to index and store all e-mails thus associated in the database, along with attachments and related data in the centralized repository of the business software, and retrieve e-mails for the selected contacts. The e-mail client system's database integrates the address retrieval element of the e-mail client with the metadata of the entities stored in the database. The indexing and storing functions of the e-mail client also identifies the relevant metadata of the entity in the business database, stores a copy of the e-mail data in the database, the e-mail data being attached and indexed to the data of the particular entity to which the e-mail is sent.

### BRIEF DESCRIPTION OF THE DRAWINGS

These and other aspects of the invention will become apparent from the following description read in conjunction with the accompanying drawings:

FIG. 1 is a system that incorporates the e-mail client system in accordance with the invention;

FIG. 2 illustrates a diagram showing the functional capabilities of Everest E-mail;

FIG. 3A illustrates a flow diagram showing the process flow for managing e-mails from/to Everest customer/vendor/users and external entities;

FIG. 3B illustrates a computer implemented e-mail client system in accordance with the invention;

FIG. 4 is the user interface of Everest E-mail;

FIG. 5 illustrates a view of the e-mails pertaining to a specific customer from the customer browser; and

FIGS. 6A and 6B illustrate an example of a database table that contains the e-mail addresses associated with the e-mail client.

### DETAILED DESCRIPTION OF A PREFERRED EMBODIMENT

The invention is particularly applicable to an e-mail client system for use with a business software application, such as Everest developed by iCode. It is in this context that the invention will be described. The e-mail client system and method in accordance with the invention has greater utility, however, and can be extended to another system in which it may be desirable to have an e-mail client with the features described herein. For purposes of the following description, certain specific terms here will be defined:

Everest: A business software solution, developed and sold by iCode, Inc., which is used as example herein of a business software application into which the e-mail client in accordance with the invention may be integrated.

Everest E-mail: An example of an e-mail client, that integrates with the Everest database.

Entities/Business Contacts/Contacts: Organizations or persons such as customers/vendors/prospects that a business deals with in the course of carrying out its activities.

Profiles: A set of data relating to an entity as stored in Everest.

Browsers: A summary display of related profiles as displayed in Everest.

A business software application system that may incorporate the e-mail client in accordance with the invention is described as follows.

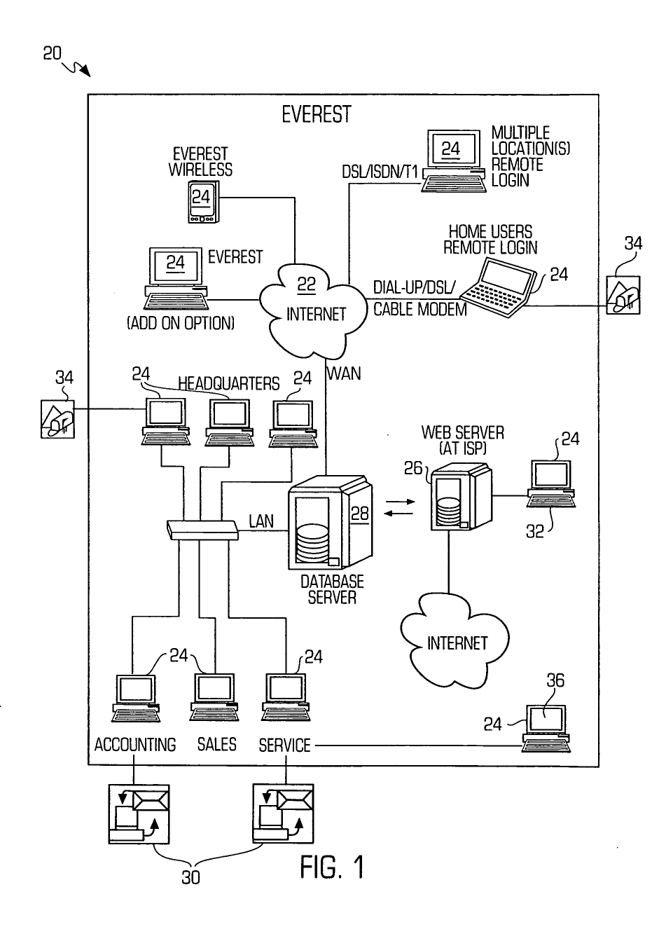

FIG. 1 is an overall block diagram of a business software application system 20 that incorporates an e-mail management system (e-mail client) in accordance with the invention. In the preferred embodiment, the system 20 is the Everest software application that is being executed on a computer network/system as shown. However, the system may also be any other business software application. The system 20 is connected together by a computer network 22, such as the Internet as shown, the World Wide Web (Web) or any other computer network, wherein a plurality of different computing resources 24 are connected together. Each computing resource 24 is a computer system that is capable of executing computer software code to implement the business software application and the e-mail management system, such as the laptop, wireless device, and desktop systems as shown. Each computing resource has the well known components of a computer system, such as one or more processors, memory, such as SRAM or DRAM or flash memory, a persistent storage device, such as a hard disk drive, optical disk drive, or tape drive, and optional input/output devices, such as keyboards, mice, LCDs, CRTs, and printers. The system is not limited to any particular type of computing resource because the business software application may be implemented using various computer systems. The computing resources of the system 20 are connected together by a wide area network (WAN) and a local area network (LAN) as shown. As shown, the system 20 also may include a Web Server 26 that permits Web access to the system by the computer resources 24. The system 20 may further include a Database Server 28 which is connected to the various computing resources and acts as a data repository for the system and its parts. The elements of the Database Server 28 are well known and not described herein. In a preferred embodiment, a Microsoft® SQL Database Server may be used, but the Database Server may also be implemented using an Oracle or a Siebel product.

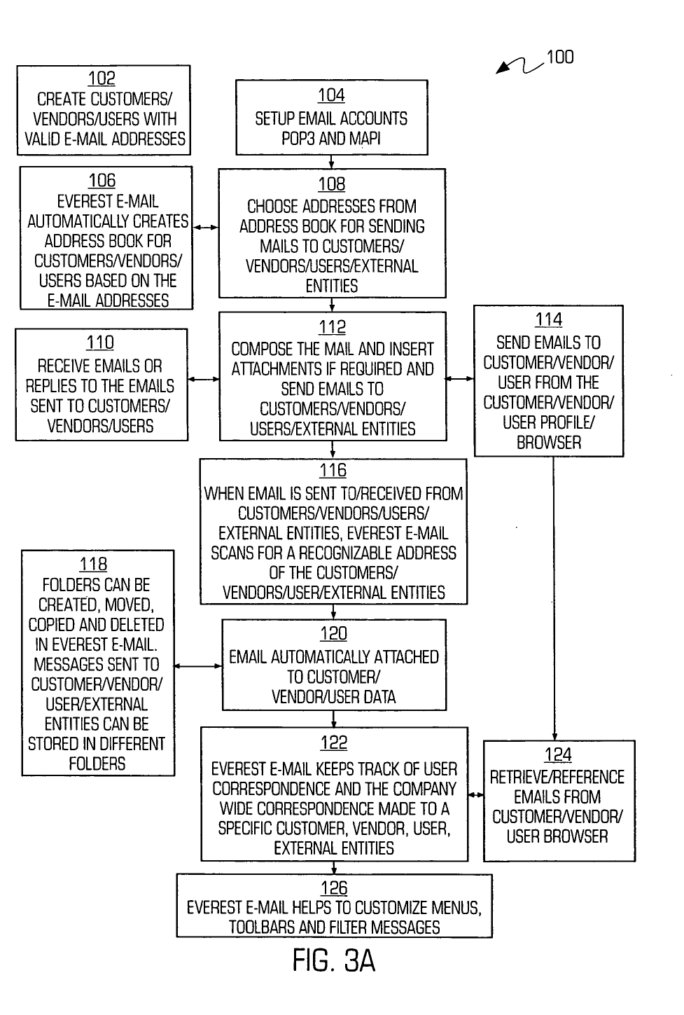

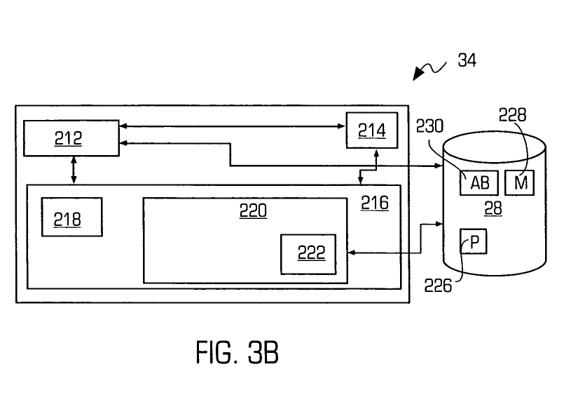

The system may further include an e-mail management system 30 that is integrated within a Microsoft Outlook e-mail client. The e-mail management system allows employees to be more informed on all e-mail interactions between customers and anyone in the organization and permits access to all such e-mails stored within Everest. In a preferred embodiment, the e-mail management system is one or more pieces of software code, executing on a computing resource 24, that perform the various functions of the mail management system. The system may further include a PageBoost system 32 that is a search engine solution, which integrates with Everest by generating optimized HTML pages ready to be submitted to various search engines for higher page ranking, traffic hits and seamlessly integrates with the Everest system. In a preferred embodiment, the PageBoost system is one or more pieces of software code, executing on a computing resource 24, that perform various functions. The system may further include an e-mail client system 34 that sends and receives e-mail directly from Everest. Employees are more informed because they have access to all e-mail sent between customers, vendors and anyone in the organization, wherein the Everest E-mail client replaces any e-mail client such as Outlook and integrates with Everest. In a preferred embodiment, the e-mail client system is one or more pieces of software code, executing on a computing resource 24, that perform various functions. The e-mail client system is described below in more detail with reference to FIG. 3B. The system may further include a PayBridge system 36 that bridges between different payment processors for processing credit card transactions with different payment processors and integrates with Everest allowing customers to use their own payment processors. In a preferred embodiment, the PayBridge system is one or more pieces of software code, executing on a computing resource 24, that perform various functions. The e-mail process and system in accordance with the invention is described as follows.

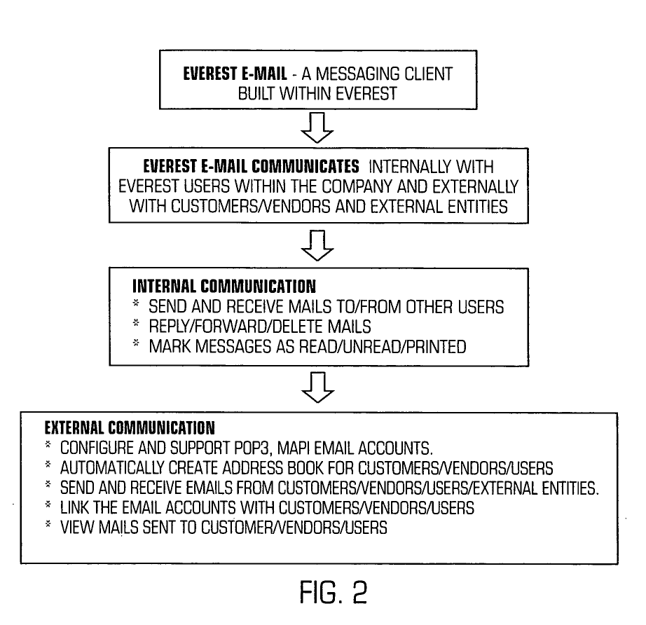

FIG. 2 is a diagram illustrating the capabilities of the e-mail system in accordance with the invention. The e-mail client is a messaging client application (software in the preferred embodiment) that is built within the system 20 shown above. The e-mail client communicates internally with the user of the system 20 and externally with customers/vendors and other external entities. For internal communications, the e-mail client sends/receives e-mails from/to users, reply/forwards/deletes e-mails and marks messages as read/unread/printed, prints e-mails and saves e-mails to folders and other locations. For external communications, the e-mail client may configure and support POP3 and MAPI e-mail accounts, automatically create address books for customers/vendors/users, send/receive e-mails from customers/vendors/user and external entities, link the e-mail accounts with customers/vendors/users and view e-mails sent to customers/vendors/users as shown in FIG. 2. The installation process for the e-mail client system, including client accounts and preferences, is described as follows.

An e-mail account is a group of settings that defines how Everest E-mail is set up for a particular user. Everest E-mail can be set up for dial-up Internet service, corporate e-mail servers, or both. Both POP3 and MAPI e-mail accounts can be setup in Everest E-mail. If Everest is needed to work with a different set of information services, it may be useful to create additional e-mail accounts. If more than one person uses the same computer, each person should have a separate e-mail account created for his or her own use.

The setup options allow users to create, modify and delete the e-mail accounts and set preferences. Everest E-mail enables users set up options for message formats while replying, forwarding and sending messages. Everest E-mail can send and receive messages in three formats:
Plain Text: Using this option, a user can send e-mails that do not include text formatting.
Rich Text Format: Using this option, a user can send e-mails with formatted text, bullets, and alignment.
HTML: Using this option, a user can send e-mails with text formatting, numbering, bullets, alignment, horizontal lines, backgrounds, HTML styles and Web pages.

Each e-mail account permits the user to send e-mails from browsers and profiles using Everest E-mail. In addition, the arrival of new e-mail can be notified to the user either through a notification message or by playing a sound.

The e-mail client also facilitates the creation of an address book. In particular, an address book containing the e-mail addresses specified in the entity profiles is automatically created. These addresses are tagged and sorted based on the type of entity and are retrievable based on this type. The address book contains the e-mail addresses of three entity types: users, customers and vendors. Multiple addresses can be stored for each entity defined in Everest. Whenever a new customer/vendor/user is created in Everest, the e-mail address from the profile is accessible through the address book. Additional entries in the address book for any other type of contacts can also be created and used.

The e-mail client also permits the sending, receiving and managing of e-mail messages.

Users familiar with any popular generic e-mail client can comfortably use Everest E-mail to e-mail the customers/vendors/other users of the organization. The composing element of Everest E-mail allows users to select the e-mail addresses based on the entity type to which the e-mail is addressed. The address retrieval element of the e-mail client is integrated with the metadata of the entities stored in Everest database. The relevant addresses are accessible by the classification of the entities that Everest allows—vendors, customers, users and other contacts. Furthermore, the retrieval is based on the unique identifiers or descriptions that the entities have been assigned in the business software thereby enhancing the ease of retrieval.

The e-mail client has the capability to manage received and sent e-mails in different folders, move, copy or delete the e-mails, and thus provides a mechanism to organize and manage the e-mail communication carried out with all entities. The e-mail client also handles the storing, indexing and retrieval of e-mails. Whenever e-mails are sent to different entities, Everest E-mail searches for the relevant metadata of the entity in the business database (Everest) and a copy of the e-mail data is stored in the business database. This e-mail data is attached and indexed to the data of the particular entity to which the e-mail is sent. Thus, a history of all e-mail communication is maintained, attached and indexed to the entity metadata and becomes retrievable from within the business software. In a similar way, whenever a new e-mail is received through the Everest E-mail, the addresses database of the business software is searched for a matching entry of the e-mail address from which the e-mail has been received. If the search is successful, the e-mail data is copied to the database and indexed to the entity corresponding to the e-mail address.

Apart from providing the user with an ability to access e-mails from the e-mail client itself, the integration provided with Everest, extends the usefulness to access these e-mails from the entity profiles within the business software. The attached e-mails are available to all users of the software who are allowed to access data pertaining to the entities and can be retrieved and referenced as and when required.

The retrieval mechanism allows the users to view only those messages sent by them or by all users. A filter and search functionality allows retrieval of e-mails based on various parameters the entity received such as from/sent to, time, size, folders stored and subject. Advanced queries can also be built for these filter and search operations with the queries automatically converted to SQL by Everest E-mail. An e-mail client method in accordance with the invention is described in more detail as follows.

FIG. 3A illustrates a process 100 of managing e-mail messages from customers/vendors/users and external entities in accordance with the invention. The steps described below may occur at various times and are not dependent on each other for execution. In steps 102 and 104, the e-mail client system is set up during which customer/vendor/user entity information with a valid e-mail address is created and e-mail accounts (either POP3 or MAPI) are set up, respectively. In step 106, the e-mail client may automatically create an address book for customers/vendors/users based on the e-mail addresses of the customers/vendors/users. In step 108, the e-mail client, based on user input, may choose addresses from a previously created address book for sending e-mail messages to customers/vendors/users or external entities. In step 110, the e-mail client may receive e-mails or replies from e-mails sent to the customers/vendors/users or external entities. In step 112, the e-mail client permits the user to compose an e-mail and insert attachments, if required, and send e-mails to customers/vendors/users or external entities. In step 114, the e-mail client permits the user to send an e-mail to customers/vendors/users or external entities from the customers/vendors/users or external entities profile/browser in the e-mail client. In step 116, the e-mail client, when an e-mail is sent to/received from customers/vendors/users or external entities, scans for a recognizable address of the customers/vendors/users or external entities in the e-mail by scanning the header of the e-mail message in a known manner. In step 118, the e-mail client permits folders to be created, moved, copied and deleted in the e-mail client system and messages from customers/vendors/users or external entities may be stored into the folders. In step 120, if a recognizable address is found in a header, the e-mail message is automatically attached to the customers/vendors/users or external entity data stored in the database 202 of the business software application system. In step 122, the e-mail client tracks e-mail client user correspondence and company wide correspondence made to a specific customer/vendor/user or external entity. In step 124, the e-mail client permits the user to retrieve/reference e-mails from customers/vendors/users or external entities using the e-mail client browser. In step 126, the e-mail client permits the user to customize menus, toolbars and filter messages of the e-mail client system. An example of the computer system implemented e-mail client system in accordance with the invention is described as follows.

FIG. 3B is a block diagram illustrating an example of a computer implemented e-mail client system 34 in accordance with the invention. In accordance with the invention, the e-mail client system may also be implemented as one or more software modules/pieces of code wherein each module/piece of code has a plurality of lines of instructions/code residing on a physical data storage medium, such as a CD, DVD or other storage medium, wherein the software is installed from the CD onto a computer system for execution or executed by the computer system directly from the physical data storage medium. Similarly, the e-mail client system may be implemented as pieces of software embedded onto a hardware device wherein a computer system executes the e-mail client system using the hardware device. The computer implemented system 34 comprises various well known computer resource components whose function and operation are not described as they are well known, including one or more processors 212, a persistent storage device 214, such as a hard disk drive, optical drive, tape drive or flash memory and a memory 216, such as DRAM or SRAM, that stores the data and instructions being executed by the computer while the computer is turned on. The computer system 34 may further include other well known components such as various input/output devices and devices that connect the computer system to the Internet and a computer network.

To implement the e-mail client system in accordance with the invention, the computer implemented system includes the database 28 described above. The computer implemented system 34 further includes one or more pieces of software/modules that implement the e-mail management system such as a well known operating system 218, an e-mail client 220 in accordance with the invention with a user interface portion 222. In the example shown, these pieces of software reside in the memory 216 and are executed by the processor 212 to implement the e-mail client system. The e-mail client is an e-mail client with the capabilities shown in FIG. 3A that may be integrated into the e-mail management system in accordance with the invention. The user interface portion 222 may generate the user interfaces presented to the user during the execution of the e-mail client system. In accordance with the invention, the e-mail client system may generate one or more customer/vendor/user or external entity profiles 226 that are stored in the database 28, may store the e-mail messages and attachments 228 into the database and may store address books 230 for a particular customer/vendor/user or external entity in the database 28. Examples of the user interface of the e-mail client system in accordance with the invention are described as follows.

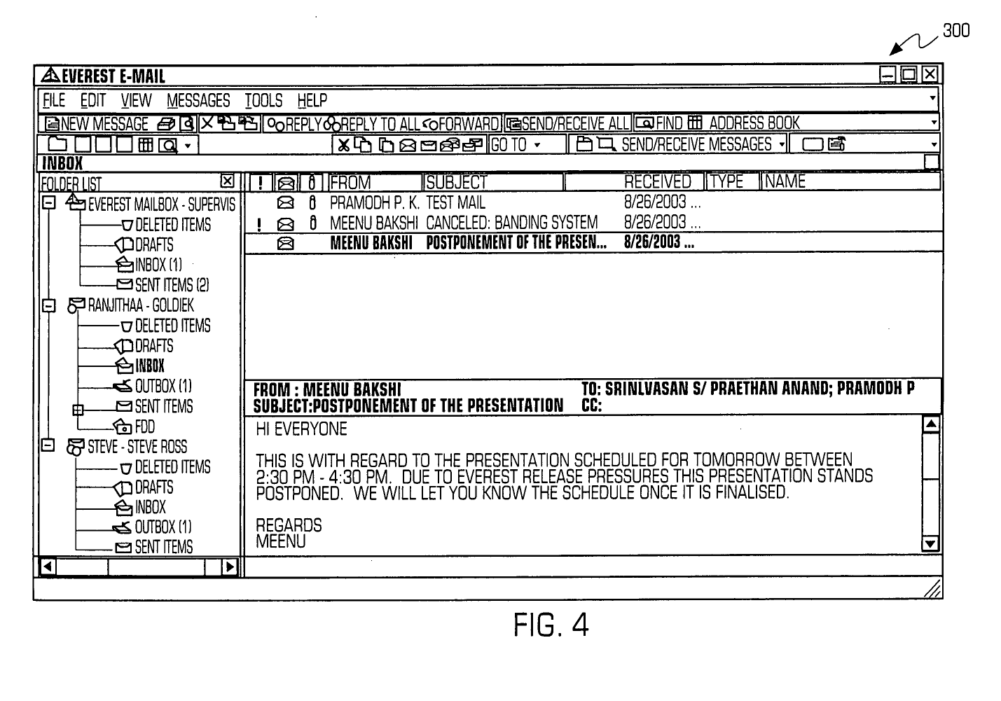

FIG. 4 illustrates an example of the e-mail client user interface 300 in accordance with the invention. The user interface permits a user to perform the typical e-mail functions associated with a typical e-mail client along with the specialized functions associated with the e-mail client system in accordance with the invention. In the example shown in FIG. 4, a user of the e-mail client is reviewing a message in a preview pane. In this example, the user has access to several different users' e-mail inboxes and those e-mail inboxes are displayed. If the user only had access to his or her own e-mail inbox, then only his or her own inbox and messages would appear in the user interface. Thus, the e-mail client system includes a security feature that permits different users of the systems to be given different levels of access and privileges within the e-mail system.

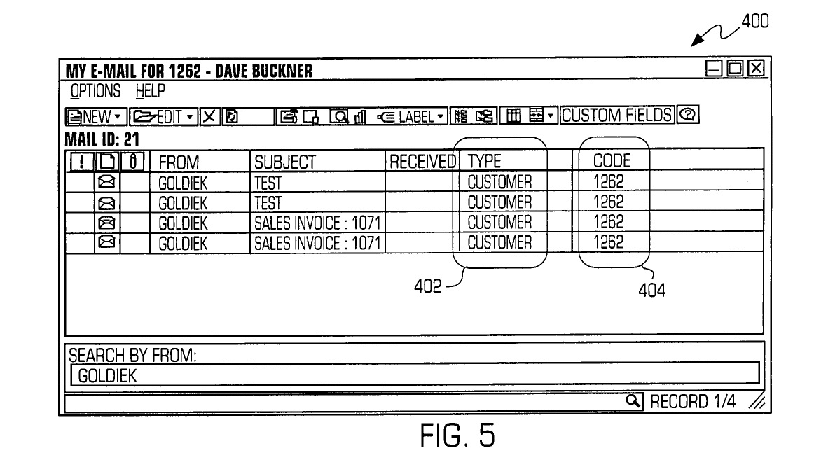

FIG. 5 illustrates a user interface 400 of the e-mails pertaining to a specific customer from the customer browser. In particular, the user interface permits a user of the e-mail client to search for messages to/from a particular individual/external entity/customer. As shown in the user interface, each e-mail message contained in the e-mail client (and hence stored in the database 28 of the business software application system) has one or more fields that are specific to a particular individual/external entity or customer. In particular, each message may have a type field 402 and a code field 404. The type field associates the message with a particular type of entity, such as a customer (shown), a vendor or a user, while the code field associates that message with a particular external entity. In the example shown, each external entity associated with the business software application system has a unique identification number associated with that entity so that messages may be searched for based on that entity. In the example shown in FIG. 5, messages from a particular user were searched and the user can see that all of the messages are associated with the same external entity.

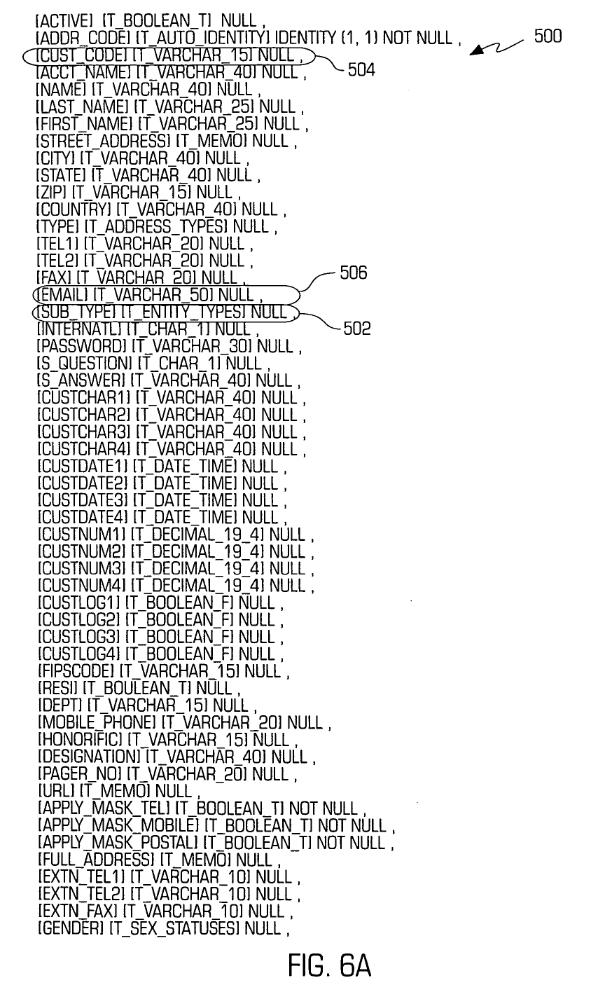

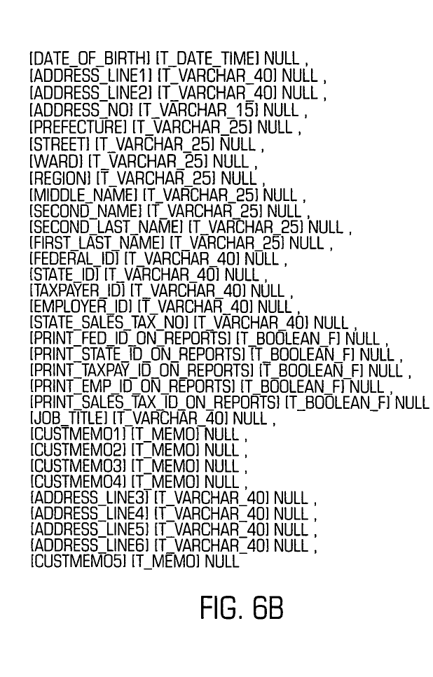

FIGS. 6A and 6B illustrate an example of a database table 500 that contains the type field and code field described above. In particular, the database table contains a SUB_TYPE field 502 that corresponds to the type field 402 and a CUST_CODE field 504 that corresponds to the code field 404. The database table also connects/associates an e-mail address (see EMAIL field 506 in FIG. 6A) with an entity type and code as shown so that that particular association is stored in the database.

Although the e-mail client of the present invention is described with reference to applicant's own business software known as “Everest”, the same e-mail client can be used with other well known business software applications with the required modification, which can be done by any person skilled in the field of computer software development.

The present invention provides a method to integrate an e-mail client with a business software application so as to enable the user to send and receive e-mails and also store, index and retrieve the e-mails in the database. Everest E-mail allows a user to manage internal and external e-mail communication. The invention provides a mechanism for the user to send and receive e-mails to/from other users, reply to e-mails, forward and delete e-mails, within and outside the organization. Users can also mark messages as read or unread and print e-mails. There is also a method for structuring, storing and retrieving e-mail communication of internal and external entities. This method has capabilities to create new folders, copy folders, delete folders, move folders, copy or move e-mails to different folders.

By integrating the e-mail client of the present invention with the database of the business software such as Everest, there is also provided an apparatus to centralize communication with external entities by providing various features. For example, the system provides configuration and supports POP3 and MAPI e-mail accounts for external communication. Internal communication does not require setting up e-mail accounts such as POP3 or MAPI. The system also provides an e-mail client for sending and receiving e-mails from customers, vendors and external entities. The system also scans the Inbox for each account and when a match is found, the system links the e-mail address with the customer or vendor. The system also views all e-mails sent to a customer/vendor by any user in the organization ensuring that no correspondence is lost or is confined to a single user's Inbox. The system also automatically creates an address book with all customer/vendor e-mail addresses.

While the foregoing has been with reference to a particular embodiment of the invention, changes in this embodiment may be made without departing from the principles and spirit of the invention, the scope of which is defined by the appended set of claims.

1. A method to integrate an e-mail client with a business software application and its database, the method comprising:
setting up one or more e-mail accounts for each user of the business software wherein each account is configured for the preferences of each user;
combining a global address book from a e-mail server, a user's personal address book and the e-mail addresses of contacts in the database of the business software together to generate a centralized database of e-mail addresses;
associating an e-mail message with a contact in the database of the business software;
storing the e-mail message in the centralized database of the business software according to the contact associated with the e-mail message; and
retrieving messages from the centralized database based on a selected contact.

2. The method of claim 1, wherein storing the e-mail message further comprises storing the e-mail message and its attachments into the database of the business software.

3. A method of claim 1, wherein the messages formats used are Plain Text, Rich Text Format and Hypertext Markup Language.

4. An e-mail client system comprising a computer program configured to execute on a processor, the computer program further comprising:
instructions that set up one or more e-mail accounts for each user of the business software wherein each account is configured for the preferences of each user;
instructions that combine a global address book from a e-mail server, a user's personal address book and the e-mail addresses of contacts in the database of the business software together to generate a centralized database of e-mail addresses;
instructions that associate an e-mail message with a contact in the database of the business software;
instructions that store the e-mail message in the centralized database of the business software according to the contact associated with the e-mail message; and
instructions that retrieve messages from the centralized database based on a selected contact.

5. The system of claim 4, wherein instructions that store the e-mail message further comprises instructions that store the e-mail message and its attachments into the database of the business software.

6. A system of claim 4, wherein the messages formats used are Plain Text, Rich Text Format and Hypertext Markup Language.

7. An e-mail client system comprising:
means for setting up one or more e-mail accounts for each user of the business software wherein each account is configured for the preferences of each user;
means for combining a global address book from a e-mail server, a user's personal address book and the e-mail addresses of contacts in the database of the business software together to generate a centralized database of e-mail addresses;
means for associating an e-mail message with a contact in the database of the business software;
means for storing the e-mail message in the centralized database of the business software according to the contact associated with the e-mail message; and
means for retrieving messages from the centralized database based on a selected contact.

8. The system of claim 7, wherein the storing means further comprises means for storing the e-mail message and its attachments into the database of the business software.

9. A system of claim 7, wherein the messages formats used are Plain Text, Rich Text Format and Hypertext Markup Language.

10. An e-mail client system of claim 7, wherein the combining means further comprises means for integrating the address retrieval element of the e-mail client with the metadata of the entities stored in the database.

11. An e-mail client system as claimed in claim 7, wherein the associating means further comprises means for identifying the relevant metadata of the entity in the business database and means for storing a copy of the e-mail data in the database, the e-mail data being attached and indexed to the data of the particular entity to which the e-mail is sent.
